(19) United States
(12) Patent Application Publication
(10) Pub. No.: US 2004/0031061 A1
(43) Pub. Date: Feb. 12, 2004

(54) System and method for providing real-time ticker information

(75) Inventors: John McCalla, Montreal (CA); Yves D'Aoust, St-Lambert (CA)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Bluestreak Technology Inc., Irving, TX (US)

(21) Appl. No.: 10/631,209

(22) Filed: Jul. 31, 2003

Related U.S. Application Data
(60) Provisional application No. 60/400,315, filed on Jul. 31, 2002.
(60) Provisional application No. 60/400,316, filed on Jul. 31, 2002.
(60) Provisional application No. 60/400,317, filed on Jul. 31, 2002.

(51) Int. Cl. H04N 7/16; H04N 11/00

(52) U.S. Cl. 725/135; 725/142; 348/461; 348/468

(57) ABSTRACT

The invention, generally addresses problems associated with, for example, providing on a device having limited graphical, memory or processing capabilities, a “ticker” service, i.e. an automated display of textual information, such as news related items, news stories, stock prices, weather, sports information, etc., especially, for example, one over an interactive television medium. A system and method for providing a ticker service that implements a preferred embodiment of the invention is used to advantage in an interactive television medium. A viewer or subscriber is able to watch information displayed by the ticker service on his or her television, while watching regular television programming. In its preferred embodiment, the system does not degrade the performance of the interactive television network. This preferred embodiment also demonstrates an efficient user navigation mechanism for interacting with the service using, for example, a television remote control.

### RELATED APPLICATIONS

This patent application claims the benefit of Provisional Patent Application Serial No. 60/400,310, entitled Internet Browsing for Television Set-Top Boxes, filed on Jul. 31, 2002; Provisional Patent Application Serial No. 60/400,315, entitled TV Ticker, filed on Jul. 31, 2002; and Provisional Patent Application Serial No. 60/400,317, entitled VOD-Based Game Playing, filed on Jul. 31, 2002; the disclosures of all of which are incorporated herein by reference.

### TECHNICAL FIELD OF THE INVENTION

The present invention relates generally to the field of interactive television.

### BACKGROUND OF THE INVENTION

There are several problems in presenting multimedia content, including for example, web content and games, on or using computer devices having limited memory, processing capability, output capabilities, display capabilities, and/or communication capability, such as interactive television systems. The first one is the size of the computer programs used in connection with presenting the multimedia content. The typical interactive set-top box for cable television reception only has around 8 MB of memory. A satellite television receiver has even less memory typically between 2 and 4 MB. A typical interactive or digital television “set-top box,” as cable and satellite television receivers are often called, is quite limited in capabilities compared to what exists on a regular computer.

A second problem is related to the screen resolution. For example, a television screen has substantially fewer pixels than the typical computer screen. In NTSC (National Television Standards Committee) mode, the effective resolution is 646 by 486. For PAL (Phase Alternate Lines), the resolution is 768 by 576.

A third problem is transmission of multimedia content and applications, for example on an interactive or on-demand basis, often imposes significant bandwidth demands on networks to which these devices may be connected. Often, these networks are not capable of, or were not intended for, transmitting large multimedia files and applications.

### SUMMARY OF THE INVENTION

The invention, generally addresses problems associated with, for example, providing on a device having limited graphical, memory or processing capabilities, a “ticker” service, i.e. an automated display of textual information, such as news related items, news stories, stock prices, weather, sports information, advertisements, etc., especially, for example, one over an interactive television medium. A system and method for providing a ticker service that implements a preferred embodiment of the invention is used to advantage in an interactive television medium. A viewer or subscriber is able to watch information displayed by the ticker service on his or her television, while watching regular television programming. In its preferred embodiment, the system does not degrade the performance of the interactive television network. This preferred embodiment also demonstrates an efficient user navigation mechanism for interacting with the service using, for example, a television remote control.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an example of an interactive or digital television system in which the present invention may be employed to particular advantage;

FIG. 2 is a high level diagram of a system for retrieving content by an interactive television device;

FIG. 3 illustrates an exemplary television ticker;

FIG. 4 illustrates an exemplary layout for a detailed version of an information item;

FIG. 5 is an exemplary layout for an information hierarchy;

FIG. 6 illustrates different parts of an exemplary information item;

FIG. 7 is a high level diagram of a system for providing information;

FIG. 8A is a flowchart of an exemplary method for updating an information hierarchy database;

FIG. 8B is a flowchart of an exemplary method for refreshing an information hierarchy of a broadcast file system;

FIG. 8C is a flowchart of an exemplary method for creating an information hierarchy for use with an interactive television device;

FIG. 9A is a flowchart of an exemplary method for specifying a timer for an information item;

FIG. 9B is a flowchart of an exemplary method for expiring an information item; and

FIG. 10 is a flowchart of an exemplary method for automatically scrolling through various items in the television ticker while allowing a user to take control.

### DETAILED DESCRIPTION OF THE DRAWINGS

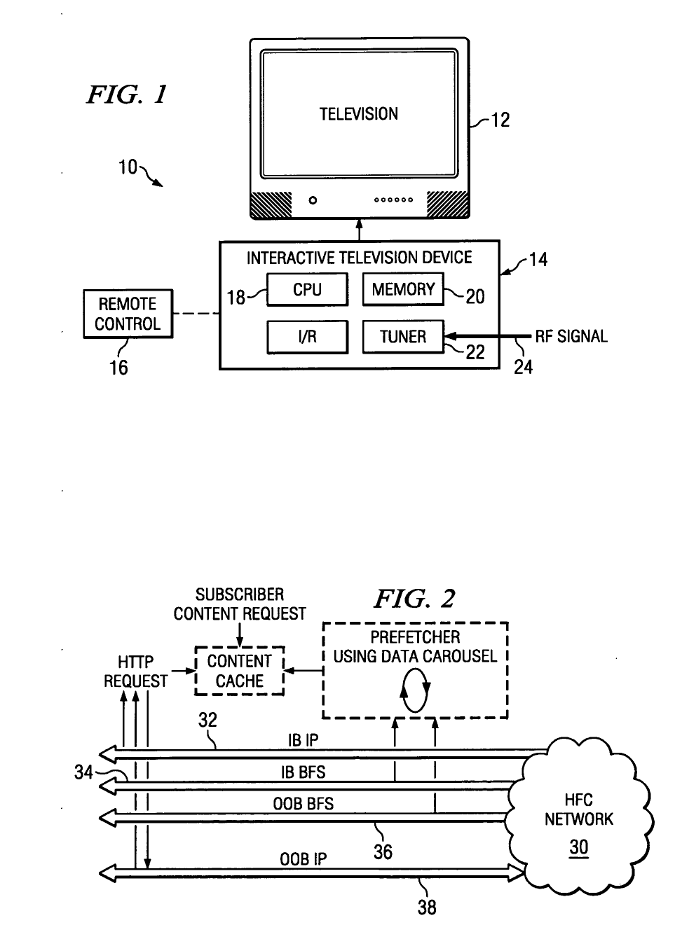

The preferred embodiment of the present invention and its advantages are best understood by referring to FIGS. 1 through 10 of the drawings.

FIG. 1 is a block diagram of an example of an interactive or digital television system 10 in which the present invention may be employed to particular advantage. The terms “interactive television” and “digital television” are used interchangeably herein. Interactive television refers to the television experience where a user can interact with content presented on his/her television screen 12. To enable this interaction, it is desirable that the viewer have an interactive television device 14, like a set-top box, and a remote control 16. Interactive television device 14 is not limited to a set-top box. If desired, television set 12 could integrate the interactive television device, or the interactive television device could be incorporated into another device connected to the television set. Interactive television device 14 is an example of a device having limited processing, memory and display capabilities.

Interactive television device 14 accepts user input and presents the content to the viewer. Depending on the content, various interaction methods are available. Remote control 16 is the most common tool for interaction with the interactive television device 14. If desired, a wireless keyboard may be used. Most commonly, navigation and selection keys (e.g. arrows, page up/down) are used to select the content of interest and activate it. The user interface of interactive television applications is preferably operable by remote control 16.

In general, a typical interactive television device 14 can be characterized as a computer, which executes software instructions, with circuitry for processing data streams, for example data streams carried by modulated RF (Radio Frequency) signals 24. An interactive television device has, as compared to personal and other types of computers, limited processing and data storage capabilities. Interactive television device 14 comprises a central processing unit (CPU) 18, a memory 20, for example random access memory (RAM) and read only memory (ROM), and/or a television tuner 22.

Interactive television device 14 communicates with a network designed primarily for transmission of television services. There are presently three types of widely used television transmission networks: DSL (Digital Subscriber line), cable and satellite. Content (television programs, pay per view programming, interactive applications, etc.) is encoded into digital signals, for example RF signals, transmitted over the network. Interactive television device 14 receives digital signal 24 and processes it. When a viewer is watching conventional television (as opposed to interactive television), digital signal 24 passes through interactive television device 14 without any processing. Using remote control 16, the viewer has the same interactions (e.g., channel up/down, entering a channel number, etc.) with interactive television device 14 that he/she would with his/her regular television set 12.

Interactive television device 14 may store one or more resident applications. A resident application is a software program (an application) loaded in nonvolatile or volatile memory to do a particular task, e.g. present a services menu. The resident application is present in memory to respond to user actions.

When a resident application is running, it may need content or other application to be also loaded into memory. The resident application looks at information carried by digital signal 24 to check if the information that it is looking for is available there. A digital signal may comprise several parts. For example, one part may be contained in the analog television channels while another may be in the digital channels.

A digital signal may be used to transmit digital information, i.e. information encoded as binary digits or bits. For example, depending on the format of the digital signal, this information may be interpreted as comprising a television channel, an audio program or a data stream. Within the data stream information on directories and files may be located. Such data stream could be like any regular file system on a computer system, except that it is broadcasted. Hence, it is referred to as a broadcast file system (BFS).

When a resident application desires content or an application, the interactive television device may look for it on the BFS in the signal. If the content or application is there, it is loaded in memory. Otherwise, interactive television device 14 may request the interactive television network, to which it is connected, that the information be added to the broadcast file system. The broadcasting point of a network is a head-end. The network may comprise a packet network. Information servers are located at the head-end and the addition of information to the file system is handled by the head-end. So this combination makes the information server and interactive television device 14 equivalent to a client/server configuration.

The resident application may, as an alternative for retrieving information, communicate over an IP (Internet Protocol) network 30 that runs over, for example, a Hybrid Fiber Coaxial (HFC) network, such as the one illustrated in FIG. 2. FIG. 2 is a high level diagram of a system for retrieving content by interactive television device 14 (FIG. 1). In the illustrated example of FIG. 2, in-band (IB) channels 32 and 34 and out-of-band (OOB) channels 36 and 38 are used to communicate. IB channels 32 and 34 and OOB channels 36 and 38 are data pipes between the head-end and interactive television device 14.

When an application is activated by the viewer, the application is loaded in memory 20 where it executes. If desired, content used by the application may be loaded in memory 20 or processed directly from the broadcast file system. Various activation methods are available, e.g. a menu item, a hot key on remote control 16, etc.

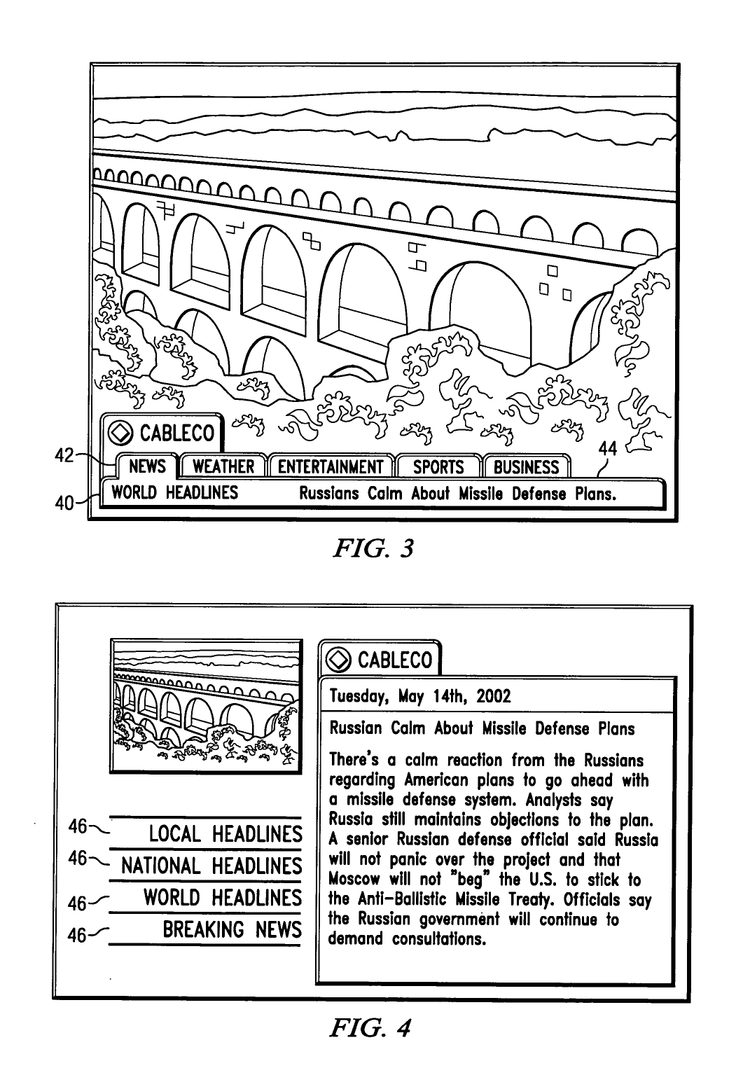

Illustrated by FIGS. 3-10 is an example of a system and method for delivering information, such as news, weather, sport, etc., that may be used to present information in a non-intrusive manner, such as on a television set while regular television programming is being watched. When used in an interactive television system, it presents information independently of the television programming and the channel being viewed, though, it could be used, if desired to also present information relevant to the program or channel being viewed. With this system and method, the information is preferably kept current while minimizing the traffic on the network. The term “network” refers to the infrastructure to deliver the television signal from the operators' head-end(s) to each of the television viewers (and back).

FIG. 3 illustrates an exemplary television ticker 40. In an exemplary embodiment, a television ticker is a graphical user interface that displays one or more lines of information, preferably unobtrusively, on a display device and that may be selected for additional information. TV ticker 40 occupies a small area of television screen 12 and is preferably composed of different components, e.g., a category selector area 42 and a display area 44. Category selector area 42 lets the viewer select the type of information that he/she wishes to look at, for example news, weather, entertainment, sports, business, advertisements, etc. For instance, a viewer may not be interested in the weather, but may be interested in sports. Using selector area 42, he/she may directly get “Sports” information.

Display area 44 is where the information for each category is displayed. In an exemplary embodiment, display area 44 only displays a subset of the information, e.g., a headline. If the viewer is interested in a particular information item, for example a headline, he/she may select the headline and receive details about it. In another example, the user may select an advertisement being displayed and get more information on the product or service being advertised. The selection of a headline is done by pressing a key on remote control 16, e.g., a shortcut key, or by navigating using the arrow keys to the display area where the headline is displayed and pressing the “Select” key (or equivalent) on remote control 16.

As illustrated in FIG. 3, if desired, TV ticker 40 may be branded. The same mechanism used to brand ticker 40 and to deliver the interactive news item could be used to bring up advertisements. For instance, a company may wish to display a banner at certain moment of the day, e.g. when a news program start.

Ticker 40 does not have to be located at the bottom of screen 12. It may be positioned anywhere on the screen. Display area 44 and category selector 42 may be dissociated if it is found to be more practical and less intrusive for the operator. If desired, ticker 40 may be partly transparent so that the viewer may see more of the television program playing behind the ticker.

With respect to presenting the detailed version of a headline, there are several possible layouts. For instance, the content may be presented to cover the full screen. An option may be to use only a portion of the screen in such a way that the viewer may still see television programming on the television screen. A combination of the two approaches is also conceivable. Various layouts can be created based on the needs of operator.

FIG. 4 illustrates an exemplary layout for a detailed version of an information item. The viewer has a non-intrusive way to browse (manually or automatically) through the news items. When desired and at his/her own time, he/she may get more details.

To provide better granularity to the information, sub-categories 46 may be used. For example, the “News” category could be broken into the following subcategories: local, national, world, breaking, etc. This creates an information hierarchy. Ticker 40 operates by presenting, in succession, the elements in a category. Ticker 40 may operate in automatic mode or be directed by the viewer. In the automatic mode, for a category, each sub-category is traversed to present its items. When a category is done, the next category may be traversed. The viewer always has the option to go directly to a category or sub-category by using the right key combination on remote control 16. A breaking news item may be presented to the viewer without the viewer having to navigate to it.

The layouts, the categories (and sub-categories) and/or the appearance (skins) may be user-configurable. Some of the elements may impact the way that interactive television device 14 will perform. For instance, if a user subscribes to all the information items, more memory will be used compared to someone selecting fewer items. If desired, TV ticker 40 may be built to load information on demand.

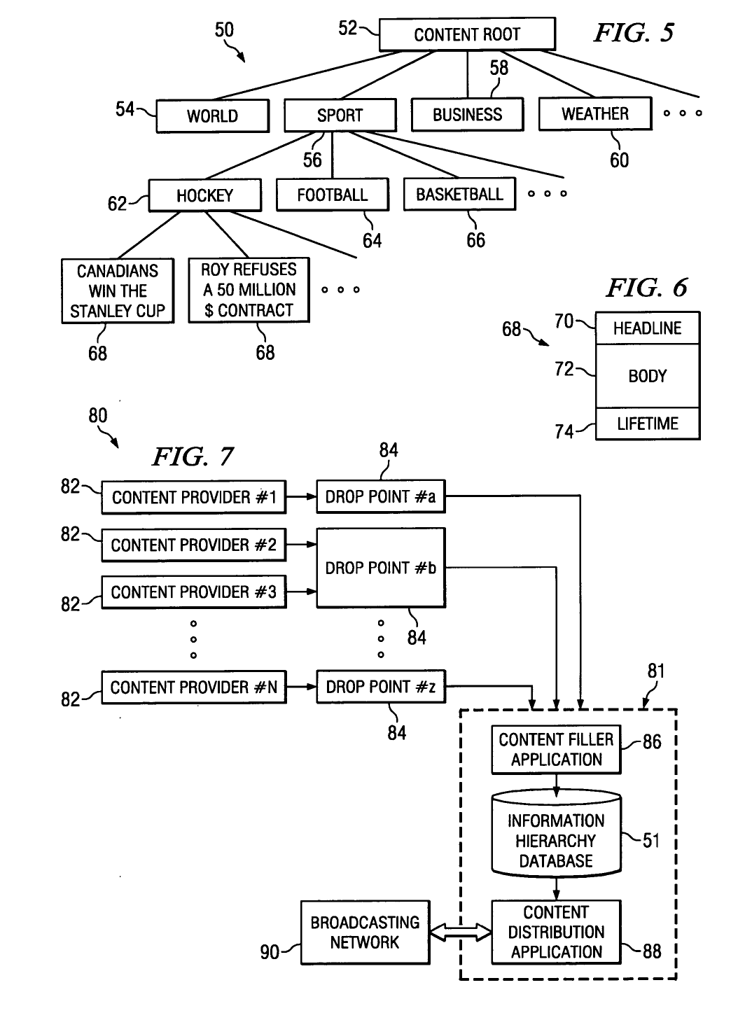

TV ticker 40 presents information to viewers. A determination of how the information presented to the viewers is organized is made. One approach is to use a hierarchy to store the information. FIG. 5 is an exemplary layout for an information hierarchy 50. At the top level, information hierarchy 50 comprises a content root 52 of all the categories 54, 56, 58, 60, for example “World,” “Sport,” “Business,” “Weather,” etc. Under each category, information hierarchy 50 may comprise sub-categories 62, 64, 66. Leaves 68 comprise the information items.

For example, in a three level hierarchy, the levels may be category, sub-category and information item. It could be possible to have more levels. The proper user interface should be provided to facilitate the navigation of the information hierarchy.

FIG. 6 illustrates different parts of information item 68 in an exemplary embodiment. Information item 68 preferably comprises three parts: a headline 70, a body 72 and a lifetime 74. More parts could be added to the information item. For example, an information item may be restricted for age concern. Headline 70 comprises what is being displayed in display area 44 of TV ticker 40. Body 72 comprises the information displayed when the viewer decides to get more details on the headline shown to him/her. Typically, body 72 contains text with some level of formatting, e.g. paragraphs, tables, etc. as illustrated in FIG. 4.

Lifetime 74 determines if the item should be removed or when it should be updated. For example, the weather information should be refreshed every hour while a news item should disappear after a day. This element is very desirable on interactive television device 14 because it permits management of the limited on-board memory 20 by deleting “expired” items. For example, eight megabytes of memory is the base configuration for many modern set-top boxes. It should be noted that in Europe it is not rare to find set-top box with less than a megabyte of available memory.

There are several methods that may be used to package an information item. Preferably an item is packaged using a language, such as XML (extensible Markup Language). XML is commonly used to structure content being used on the Internet. Preferably, a packaging method which is standard and extensible is used to represent information. Here is an example of the information item in the XML format using a syntax created for this example.

```
<ITEM>
  <CATEGORY>
    Sport
    <SUBCATEGORY>
      Hockey
    </SUBCATEGORY>
  </CATEGORY>
  <HEADLINE>
    The Canadians win the Stanley Cup.
  </HEADLINE>
    <BODY>
      Last night the Montreal's Canadians defeated the . . .
    </BODY>
    <LIFETIME>
      <REFRESH_AT>
        3/15/2002 16:30
      </REFRESH_AT>
    </LIFETIME>
<ITEM>
```

The BODY section of the information item is where the details of the item are located. The content of that section preferably provides enough information to properly present the information item. Preferably, the section includes formatting information to allow text to be displayed in paragraphs. It may be possible to find one or more links to other information. For example, a uniform resource locator (URL) could be used for such a link. The URL could direct the user to the Internet or to somewhere on the BFS. Presentation languages, like XML, HTML, SWF (ShockWave Flash) may be used for controlling presentation of the information.

Depending on the nature of the information items and its update frequency, it may be appropriate to package the item in its own file. In some other cases, it may be better to group a whole category together within a single file. The advantage of having individual files for frequently updated information is that it can be accessed directly from a client. When the client desires to update the information, only this file is sent to the client.

A TV ticker application executes on interactive television device 14, and is referred to as the “client”. The client examines what is happening within the television signal (e.g. MPEG2 stream) and on one or more IP ports. TV ticker 40 may be activated using different methods: inside the television stream, user action or scheduled event. The first method comprises embedding in the television signal, for example RF signal 24 (FIG. 1), an instruction to bring up the ticker at a particular time. For instance, when an entertainment program starts, it asks for the ticker to appear with the “Entertainment” category open. The second method comprises activation by a user action. For example, the viewer goes to a services menu and selects the TV ticker. A hot key on remote control 16 may also be programmed to produce the same effect. A third method would bring up ticker 40 at a particular time, for example, when the 11 o'clock news program starts. In an exemplary embodiment, an activating trigger to display ticker 40 may be provided by a clock of interactive television device 14.

The client comprises a player for playing content in what will be referred to as an “advanced movie format”. A typical player executes a movie from start to end with no possibility of interruption or suspension. An advanced movie format is a presentation format capable of supporting, but not limited to, one or more of the following: text, graphic drawing, images, animation, sounds and program code. It is desirable that the format work in multiple resolutions. An example of such a format is the MACROMEDIA FLASH format or a subset thereof. A ticker movie describes the look of ticker 40, as well as its operation logic. The logic, described using a scripting language, defines how the movie responds to certain events. For example, the “right arrow” key on remote control 16 makes the category selector go from one tab to the next. Similarly, another key could be set to bring up more details on the current headline.

The organization of ticker 40 is based on the information being delivered to interactive television device 14. When the client starts, it creates one tab for each of the category found in the information hierarchy. The client has a copy of the information hierarchy in memory 20. Below is an example of the script, written in pseudo-code, executed when ticker 40 is started for the first time:

```
FOR each branch of the information hierarchy
  Extract the category name from the information node
  Create a tab using the category name in the ticker
END FOR
```

When ticker 40 is running, the information hierarchy is traversed to present to the viewer the headline for each information item. Ticker 40 reacts to events coming either from remote control 16, server 81, television signal 24 or from timer. For example, the following code demonstrates what happens when an event asking to bring the next information item up.

```
IF no more item in the sub-category
  IF no more sub-category
    Un-highlight the current category tab
    Find the next category
    Highlight the new category tab
    Find the first sub-category
  ELSE
    Find the next sub-category
  END IF
  Extract the sub-category name from the information node
  Display the name in the title portion of the display area
  Find the first item in the sub-category
ELSE
  Get the next item
END IF
```

Display the headline in the display area

An information item 68 (FIG. 6) comprises a lifetime 74, i.e. a period of time for which the information remains valid. The client knows when an item's lifetime is reached. The above example does not integrate the notion of lifetime. When the expiration event occurs, the client deletes the item, freeing valuable memory in interactive television device 14. An expired item will be marked to be refreshed but the refresh will only occur when the viewer tries to access the item. This approach has the effect of reducing the demands on server 81 since the client preferably only communicates with the server when necessary.

An alternative to communicating directly with a server to obtain an information item is to obtain the information from the BFS. However, this requires time from tuner 22 and this impacts the viewer's experience. More specifically reading the information on the BFS takes time and during that time, television tuner 22 is utilized for something other than displaying the television program. Consequently the viewer has to wait for tuner 22 to become available again.

In the foregoing explanation, the server includes a facility from which information is sent to the client and that may also prepare the information and keep it up to date. FIG. 7 is a high level diagram of a system 80 for providing information. Normally a network operator has several content providers 82. If desired, the network operator may be one of the content providers. The operator selects the information that he wants from the content available through content providers 82. The content is made available at a location agreed by both parties, typically an FTP site (FTP stands for File Transfer Protocol and refers to a method to transfer files on the Internet). This location is also referred to as a drop point. Drop points 84 are examples. An association is created between the content of the providers and TV ticker information hierarchy 50 stored in information hierarchy database 51. This association tells a content filler application 86 where to get the information and where to deposit it.

Content filler application 86 knows when an item is to be updated when it gets the item from the appropriate drop point. When (or at specific time) the content is changed, information hierarchy 50 is taken by a content distribution application 88 and put on the broadcasting network 90. Any method, now known or later developed, for inserting content into broadcasting network 90 may be used.

The client preferably operates under a push/pull model for expired information items. However, server 81 could push content to the client. This is done by marking an item for update. Server 81 could push the new content to the client. The disadvantage of pushing content to the client is that it affects network performance because there is no guarantee that the viewer will access the content. Because broadcasting network 90 has limited bandwidth, the traffic between the client and server 81 is preferably kept to what is desirable. When the viewer reaches an item marked for update, the information is pulled, at that time, from server 81. So a push/pull model for the client/server communication is preferably used. Content distribution application 88 is the one responding to a pull event from the client.

The concept of a pointing device, like a mouse, does not really exist on a television screen. It can be simulated but it is not common, nor practical. The navigation is performed preferably using arrow keys and/or page up/down keys. The proposed interface is based on this idea. Second there is no way to a drag movement with a television remote. This is why the user interface allows an easy navigation between categories and within the sub-categories.

Using a ticker based on an advanced movie format, the user's experience may be enhanced. The ticker does not require a separate application to display the information content. This means, for the viewers, a faster response time to get to the information item.

In accordance with an embodiment of the present invention, the lifetime portion of an information item serves two purposes: maximizing the network bandwidth and optimizing the interaction device memory 20. In the first case, device 14 knows that an item has to be refreshed and will only get the latest version when the viewer tries to access it. The client does not try to get the item as soon as the item has reached its refresh moment. It waits for the first request for access. If the item is something like the weather, this item is likely to be refreshed often. There is no need to refresh it all the time if nobody tries to access it. In the second case, when the lifetime of an item expires, it is removed from memory 20 and this memory may be made available for other purposes.

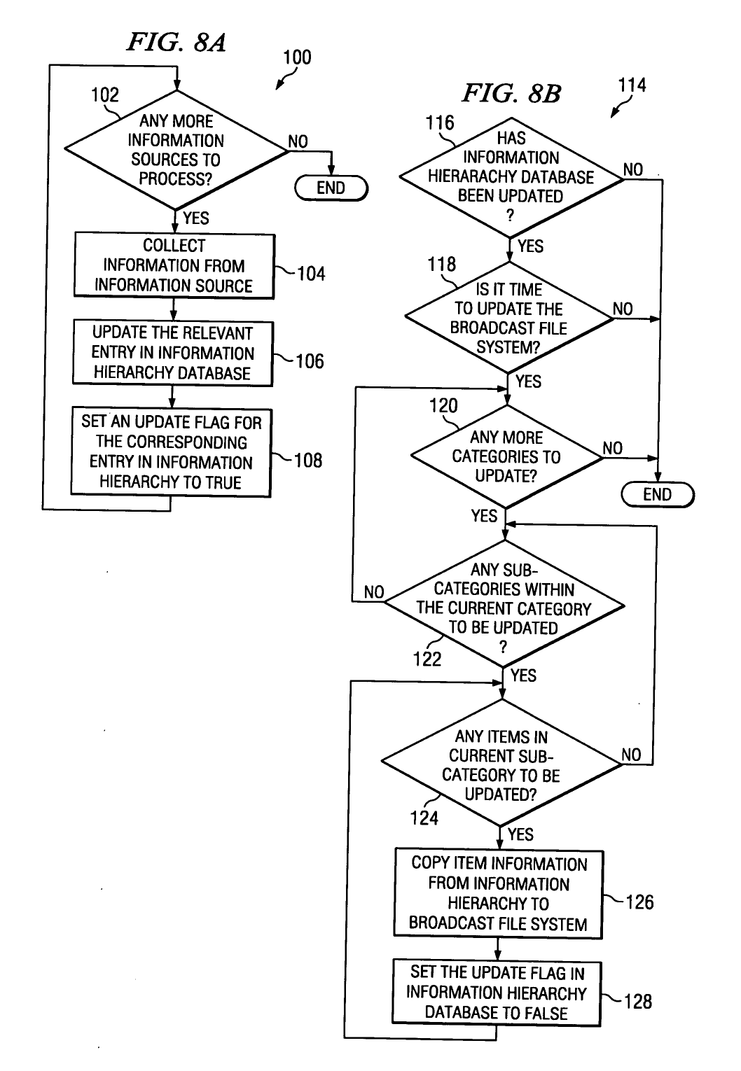

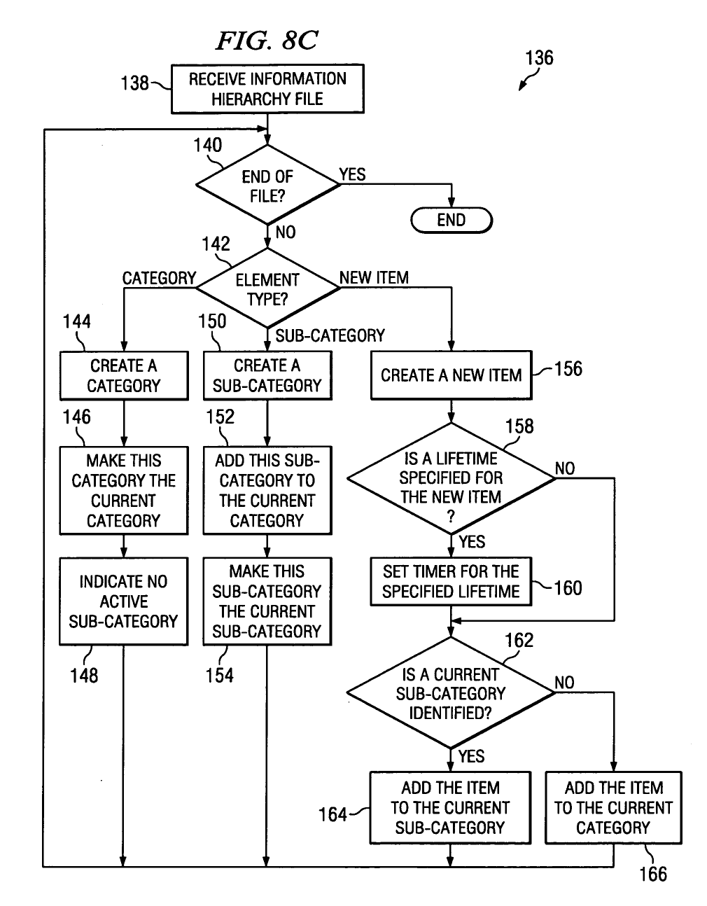

FIG. 8A is a flowchart of a method 100 for updating information hierarchy database 51. In step 102, a determination is made as to whether any more information sources 82 (FIG. 7) are to be processed. If there are no additional information sources to be processed, then the process ends. Otherwise, in step 104, information from the next information source via a drop point 84 is collected. If desired, in step 104, information from one of the drop points 84 may be collected. In step 106, a relevant entry in information hierarchy database 51 is updated with the collected information. Preferably, the relevant category, sub-category and/or information item, in information database 51 updated is selected based on the information source. For example, if only sports information is collected from a particular information source, then the collected information is added as the appropriate information item 68 (FIG. 5) under the “Sports” category. In step 108, an update flag associated with the corresponding entry in information hierarchy database 51 is set to true to indicate that the corresponding entry has been updated and the process starting at step 102 to determine whether any more information sources are to be processed may be executed. If desired, in an alternative embodiment, the update flag may be set to false to indicate that the corresponding entry has been updated.

FIG. 8B is a flowchart of a method 114 for refreshing information hierarchy 50 of the broadcast file system (BFS). In step 116, a determination is made as to whether information hierarchy database 51 has been updated. In an exemplary embodiment, this determination may be made by checking the update flag of each of the entries in information hierarchy database 51. If information hierarchy database 51 has not been updated, then the process ends. Otherwise, in step 118, a determination is made as to whether it is time to update the broadcast file system. If it is not time to update the broadcast file system, then the process ends. If it is time to update the broadcast file system, then information hierarchy 50 of information hierarchy database 51 is traversed to determine information items to be updated and the corresponding information items in the BFS are updated. As part of the process, in step 120 a determination is made as to whether any categories are to be updated. If no more categories are to be updated, then the process ends.

Otherwise, the next category is marked as the current category and in step 122, a determination is made as to whether any sub-categories within the current category are to be updated. If no sub-categories in the current category are to be updated, then the process starting at step 120 may be executed.

Otherwise, the next sub-category is marked as the current sub-category and in step 124 a determination is made as to whether any items in the current sub-category are to be updated. If no items in the current sub-category are to be updated, then the process starting at step 122 may be executed. Otherwise, in step 126, item information from information hierarchy database 51 is copied to the broadcast file system. In step 128, the update flag for the corresponding entry in information hierarchy database 51 is set to false to indicate that the corresponding entry in the BFS has been updated. The process starting at step 124 may then be executed. If desired, in an alternative embodiment, the update flag may be set to true to indicate that the corresponding entry in the BFS has been updated.

FIG. 8C is a flowchart of a method 136 for creating an information hierarchy for use with interactive television device 14. The created information hierarchy may be stored in memory 20 of interactive television device 14. In step 138, an information hierarchy file is received from the BFS via RF signal 24. Once received, an element of the file is read and in step 140, a determination is made as to whether the end of the file has been reached. If the end of the file has been reached, then the process ends. Otherwise, in step 142, a determination as to the type of element is made. If the element type is “Category”, then in step 144, a new category corresponding to the element is created. In step 146, the created category is marked as the current category. In step 148, an indication that there are currently no active sub-categories is made and the process starting at step 140 to determine whether the end of the file has been reached may be executed. It is desirable to indicate that there are currently no active sub-categories in order to avoid misclassification of an item as there are no sub-categories within the newly created category.

If in step 142, it is determined that the element type is “Sub-Category”, then in step 150, a new sub-category corresponding to the element is created. In step 152, the newly created sub-category is added to the current category. In step 154, the newly created sub-category is marked as the current sub-category and the process starting at step 140 may be executed.

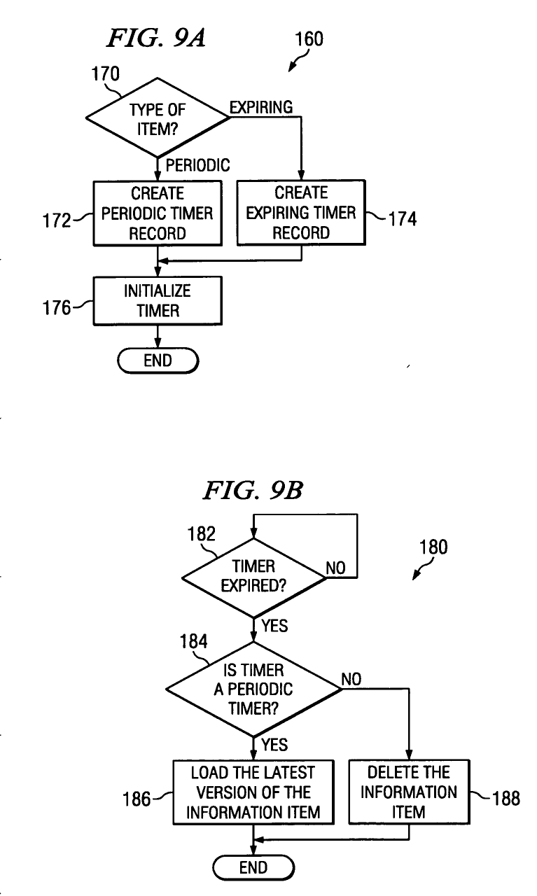

If in step 142, it is determined that the element type is “New Item”, then in step 156, a new item corresponding to the element is created. In step 158, a determination is made as to whether a lifetime has been specified for the new item. If a lifetime has not been specified for the new item, then the process starting at step 162 may be executed. Otherwise, in step 160, a timer is specified for the new item for the specified lifetime. The process starting at step 162 may then be executed. An exemplary method for specifying a timer for the new item for the specified lifetime is discussed in detail herein with reference to FIG. 9A.

In step 162, a determination is made as to whether a sub-category has been indicated as the current sub-category. If a sub-category has been indicated as the current sub-category, then in step 164, the item is added to the current sub-category and the process starting at step 140 may be executed. If a sub-category has not been indicated as the current sub-category, then in step 166, the item is added to the current category and the process starting at step 140 may be executed.

FIG. 9A is a flowchart of a method 160 for specifying a timer for an information item. In step 170, a determination as to the type of information item for which the timer is to be specified is made. An information item may be of different types. For example, an information item such as a news item, may expire after a specified period of time. Another type of information item may be one that is refreshed periodically, for example, weather, stock quote, etc. If the information item is of a type that is to be updated periodically, then in step 172 a record for a periodic timer is set. In an exemplary embodiment, at the expiration of the specified time period, the periodic timer sounds an alarm indicating that the information item associated with the periodic timer is to be refreshed. Preferably, the periodic timer also resets automatically at the expiration of the specified time period.

Otherwise, in step 174, a record for an expiring timer is set. In an exemplary embodiment, at the expiration of the specified time period, the expiring timer sounds an alarm indicating that the information item associated with the expiring timer is to be deleted. In step 176, the timer is initialized.

FIG. 9B is a flowchart of a method 180 for expiring an information item. In step 182, a determination is made as to whether the timer for the information item has expired. If the timer has expired, then in step 184, a determination is made as to whether the timer is a periodic timer. If the timer is a periodic timer, then in step 186, the latest version of the information item is loaded and the process ends. Otherwise, in step 188, the information item is deleted and the process ends.

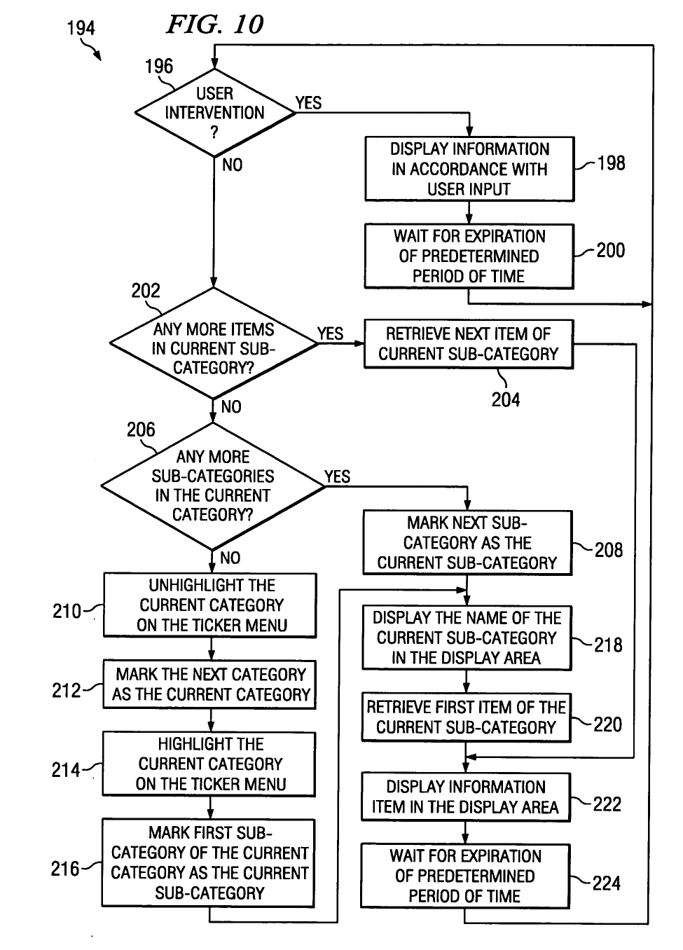

FIG. 10 is a flowchart of an exemplary method 194 for automatically scrolling through various items in television ticker 40 while allowing the user to take control. In an exemplary embodiment, various items are automatically displayed on display device 12 in a predetermined order. The user may take control at any point and navigate to a desired item.

In step 196, a determination is made as to whether an input indicating that the user desires to take over control of ticker 40 has been received. If an input indicating that the user desires to take over control is not received, then the process starting at step 202 may be executed. Otherwise, in step 198, information is displayed on ticker 40 in accordance with the user input. Thus, for example, if the user selects a particular category, then information items related to that category may be displayed on ticker 40. After the expiration of a predetermined time period within which no user input is received (step 200), the process starting at step 196 may be executed.

In step 202, a determination is made as to whether there are any more items in the current sub-category. If there are additional items in the current sub-category, then in step 204, the next information item of the current sub-category may be retrieved and the process starting at step 222 may be executed. Otherwise, in step 206, a determination is made as to whether there are any more sub-categories in the current category. If there are additional sub-categories in the current category, then in step 208, the next sub-category is marked as the current sub-category and the process starting at step 218 may be executed.

If in step 206, it is determined that there are no more sub-categories in the current category, then in step 210, the current category is un-highlighted on television ticker 40. In step 212, the next category is marked as the current category. In step 214, the current category is highlighted on television ticker 40. In step 216, the first sub-category of the current category is marked as the current sub-category and the process starting at step 218 may be executed.

In step 218, the name of the current sub-category is displayed in display area 44. In step 220, the first information item of the current sub-category is retrieved. In step 222, the information item is displayed in display area 44 and the process starting at step 224 may be executed. The information item is displayed in display area 44 for a predetermined period of time (step 224) to give the user enough time to browse the displayed information. The process starting at step 196 may then be executed to determine whether an input indicating that the user desires to take over control of ticker 40 has been received.

Embodiments of the present invention may be implemented in software, hardware, or a combination of both software and hardware. The software and/or hardware may reside on interactive television device 14 or broadcasting network 90. If desired, part of the software and/or hardware may reside on interactive television device 14 and part of the software and/or hardware may reside on broadcasting network 90.

If desired, the different steps discussed herein may be performed in any order and/or concurrently with each other. Furthermore, if desired, one or more of the above described steps may be optional or may be combined without departing from the scope of the present invention.

While the invention has been particularly shown and described by the foregoing detailed description, it will be understood by those skilled in the art that various other changes in form and detail may be made without departing from the spirit and scope of the invention.

What is claimed is:

1. A computer-readable medium, for displaying information having stored thereon an instruction set to be executed, the instruction set, when executed by a processor, causes the processor to perform the steps of:
displaying a television ticker on a display device, said television ticker comprising of a plurality of information items;
automatically displaying one or more of said plurality of information items in a predetermined order; and
interrupting said automatic display of said one or more of said plurality of information items in response to receiving a user input.

2. The computer-readable medium of claim 1, further causing the processor to perform the step of continuing said automatic display of said one or more of said plurality of information items upon expiration of a predetermined time period.

3. The computer-readable medium of claim 1, further causing the processor to perform the step of continuing said automatic display of said one or more of said plurality of information items upon expiration of a predetermined time period during which no user input is received.

4. The computer-readable medium of claim 1, wherein said plurality of information items are divided into a plurality of categories.

5. The computer-readable medium of claim 1, further causing the processor to perform the step of displaying one or more information items selected by said user.

6. The computer-readable medium of claim 1, further causing the processor to perform the steps of:
determining a category selected by said user; and
displaying one or more information items from said plurality of information items, said one or more information items being related to said selected category.

7. The computer-readable medium of claim 1, further causing the processor to perform the steps of:
determining a sub-category selected by said user; and
displaying one or more information items from said plurality of information items, said one or more information items being related to said selected sub-category.

8. The computer-readable medium of claim 4, further causing the processor to perform the steps of:
determining whether a current category comprises at least one sub-category; and
automatically displaying information items under each of said at least one subcategory in response to determining that said current category comprises at least one subcategory.

9. The computer-readable medium of claim 1, further causing the processor to perform the step of receiving said plurality of information items over a satellite system.

10. The computer-readable medium of claim 1, further causing the processor to perform the step of receiving said plurality of information items over a broadcast network.

11. The computer-readable medium of claim 1, further causing the processor to perform the step of receiving said plurality of information items over an interactive television network.

12. The computer-readable medium of claim 1, further causing the processor to perform the step of receiving said plurality of information items over an interactive television network using an RF signal.

13. The computer-readable medium of claim 1, further causing the processor to perform the step of receiving said plurality of information items over a cable system.

14. The computer-readable medium of claim 1, further causing the processor to perform the step of receiving said plurality of information items over a data network.

15. The computer-readable medium of claim 1, further causing the processor to perform the step of displaying said television ticker in response to receiving a signal to display said television ticker.

16. The computer-readable medium of claim 1, wherein said display device is associated with an interactive television device.

17. A computer-readable medium, for controlling information, having stored thereon an instruction set to be executed, the instruction set, when executed by a processor, causes the processor to perform the steps of:
receiving a plurality of information items;
storing said plurality of information items in an interactive television device;
associating a timer with selected ones of said plurality of information items; and
automatically deleting one or more of said selected ones of said plurality of information items upon expiration of their respective timers.

18. The computer-readable medium of claim 17, further causing the processor to perform the steps of:
determining a type of each of said selected ones of said plurality of information items, prior to said associating said timer; and
associating an expiring timer with said one or more of said selected ones of said plurality of information items.

19. The computer-readable medium of claim 18, further causing the processor to perform the step of associating a periodic timer with remaining ones of said selected ones of said plurality of information items.

20. The computer-readable medium of claim 17, further causing the processor to perform the steps of:
determining a type of each of said selected ones of said plurality of information items, prior to said associating said timer; and
associating a periodic timer with one or more of said selected ones of said plurality of information items.

21. The computer-readable medium of claim 17, further causing the processor to perform the step of automatically updating one or more of the remaining ones of said selected ones of said plurality of information items.

22. The computer-readable medium of claim 17, further causing the processor to perform the step of automatically replacing said deleted information items.

23. An apparatus for displaying information, comprising:
a device, comprising:
a processor; and
a memory having stored thereon an instruction set to be executed, the instruction set, when executed by said processor, causes the processor to perform the steps of:
displaying a television ticker on a display device associated with said device, said television ticker comprising of a plurality of information items;
automatically displaying one or more of said plurality of information items in a predetermined order; and
interrupting said automatic display of said one or more of said plurality of information items in response to receiving a user input.

24. The apparatus of claim 23, further causing the processor to perform the step of continuing said automatic display of said one or more of said plurality of information items upon expiration of a predetermined time period.

25. The apparatus of claim 23, further causing the processor to perform the step of continuing said automatic display of said one or more of said plurality of information items upon expiration of a predetermined time period during which no user input is received.

26. The apparatus of claim 23, wherein said plurality of information items are divided into a plurality of categories.

27. The apparatus of claim 23, further causing the processor to perform the step of displaying one or more information items selected by said user.

28. The apparatus of claim 23, further causing the processor to perform the steps of:
determining a category selected by said user; and
displaying one or more information items from said plurality of information items, said one or more information items being related to said selected category.

29. The apparatus of claim 23, further causing the processor to perform the steps of:
determining a sub-category selected by said user; and
displaying one or more information items from said plurality of information items, said one or more information items being related to said selected sub-category.

30. The apparatus of claim 26, further causing the processor to perform the steps of:
determining whether a current category comprises at least one sub-category; and
automatically displaying information items under each of said at least one subcategory in response to determining that said current category comprises at least one subcategory.

31. The apparatus of claim 23, further causing the processor to perform the step of receiving said plurality of information items over a satellite system.

32. The apparatus of claim 23, further causing the processor to perform the step of receiving said plurality of information items over a broadcast network.

33. The apparatus of claim 23, further causing the processor to perform the step of receiving said plurality of information items over an interactive television network.

34. The apparatus of claim 23, further causing the processor to perform the step of receiving said plurality of information items over an interactive television network using an RF signal.

35. The apparatus of claim 23, further causing the processor to perform the step of receiving said plurality of information items over a cable system.

36. The apparatus of claim 23, further causing the processor to perform the step of receiving said plurality of information items over a data network.

37. The apparatus of claim 23, further causing the processor to perform the step of displaying said television ticker in response to receiving a signal to display said television ticker.

38. The apparatus of claim 23, wherein said device comprises an interactive television device.

39. An apparatus for controlling information, comprising:
a device, comprising:
a processor; and
a memory having stored thereon an instruction set to be executed, the instruction set, when executed by said processor, causes the processor to perform the steps of:
receiving a plurality of information items;
storing said plurality of information items in said device;
associating a timer with selected ones of said plurality of information items; and
automatically deleting one or more of said selected ones of said plurality of information items upon expiration of their respective timers.

40. The apparatus of claim 39, further causing the processor to perform the steps of:
determining a type of each of said selected ones of said plurality of information items, prior to said associating said timer; and
associating an expiring timer with said one or more of said selected ones of said plurality of information items.

41. The apparatus of claim 40, further causing the processor to perform the step of associating a periodic timer with remaining ones of said selected ones of said plurality of information items.

42. The apparatus of claim 39, further causing the processor to perform the steps of:
determining a type of each of said selected ones of said plurality of information items, prior to said associating said timer; and
associating a periodic timer with one or more of said selected ones of said plurality of information items.

43. The apparatus of claim 39, further causing the processor to perform the step of automatically updating one or more of the remaining ones of said selected ones of said plurality of information items.

44. The apparatus of claim 39, further causing the processor to perform the step of automatically replacing said deleted information items.

45. A method for displaying information, comprising:
displaying a television ticker on a display device, said television ticker comprising of a plurality of information items;
automatically displaying one or more of said plurality of information items in a predetermined order; and
interrupting said automatic display of said one or more of said plurality of information items in response to receiving a user input.

46. The method of claim 45, further comprising continuing said automatic display of said one or more of said plurality of information items upon expiration of a predetermined time period.

47. The method of claim 45, further comprising continuing said automatic display of said one or more of said plurality of information items upon expiration of a predetermined time period during which no user input is received.

48. The method of claim 45, wherein said plurality of information items are divided into a plurality of categories.

49. The method of claim 45, further comprising displaying one or more information items selected by said user.

50. The method of claim 45, further comprising:
determining a category selected by said user; and
displaying one or more information items from said plurality of information items, said one or more information items being related to said selected category.

51. The method of claim 45, further comprising:
determining a sub-category selected by said user; and
displaying one or more information items from said plurality of information items, said one or more information items being related to said selected sub-category.

52. The method of claim 48, further comprising:
determining whether a current category comprises at least one sub-category; and
automatically displaying information items under each of said at least one subcategory in response to determining that said current category comprises at least one subcategory.

53. The method of claim 45, further comprising receiving said plurality of information items over a satellite system.

54. The method of claim 45, further comprising receiving said plurality of information items over a broadcast network.

55. The method of claim 45, further comprising receiving said plurality of information items over an interactive television network.

56. The method of claim 45, further comprising receiving said plurality of information items over an interactive television network using an RF signal.

57. The method of claim 45, further comprising receiving said plurality of information items over a cable system.

58. The method of claim 45, further comprising receiving said plurality of information items over a data network.

59. The method of claim 45, wherein said displaying said television ticker comprises displaying said television ticker in response to receiving a signal to display said television ticker.

60. The method of claim 45, wherein said display device is associated with an interactive television device

61. A method for controlling information, comprising:
receiving a plurality of information items;
storing said plurality of information items in an interactive television device;
associating a timer with selected ones of said plurality of information items; and
automatically deleting one or more of said selected ones of said plurality of information items upon expiration of their respective timers.

62. The method of claim 61, further comprising:
determining a type of each of said selected ones of said plurality of information items, prior to said associating said timer; and
associating an expiring timer with said one or more of said selected ones of said plurality of information items.

63. The method of claim 62, further comprising associating a periodic timer with remaining ones of said selected ones of said plurality of information items.

64. The method of claim 61, further comprising:
determining a type of each of said selected ones of said plurality of information items, prior to said associating said timer; and
associating a periodic timer with one or more of said selected ones of said plurality of information items.

65. The method of claim 61, further comprising automatically updating one or more of the remaining ones of said selected ones of said plurality of information items.

66. The method of claim 61, further comprising automatically replacing said deleted information items.
